(19) United States
(12) Patent Application Publication
(10) Pub. No.: US 2023/0166330 A1
(43) Pub. Date: Jun. 1, 2023

(54) PRINTABLE HARD FERROUS METALLIC ALLOYS FOR ADDITIVE MANUFACTURING BY DIRECT ENERGY DEPOSITION PROCESSES

(71) Applicant: MACLEAN-FOGG COMPANY, Mundelein, IL (US)

(72) Inventors: Faith OEHLERKING, Mundelein, IL (US); Jonathan TRENKLE, Mundelein, IL (US); Harald LEMKE, Mundelein, IL (US)

(73) Assignee: MACLEAN-FOGG COMPANY, Mundelein, IL (US)

(21) Appl. No.: 17/919,102

(22) PCT Filed: Apr. 14, 2021
(86) PCT No.: PCT/US2021/027237

§ 371 Date: Oct. 14, 2022

Related U.S. Application Data
(60) Provisional application No. 63/009,818, filed on Apr. 14, 2020.

(51) Int. Cl. B22F 10/25; C22C 38/54; C22C 38/48; C22C 38/44; C22C 38/42; C22C 38/04; C22C 38/02; C22C 38/00; B22F 10/64; B22F 10/62; B33Y 10/00; B33Y 40/20; B33Y 70/00; B33Y 80/00

(52) U.S. Cl. CPC B22F 10/25; C22C 38/54; C22C 38/48; C22C 38/44; C22C 38/42; C22C 38/04; C22C 38/02; C22C 38/001; B22F 10/64; B22F 10/62; B33Y 10/00; B33Y 40/20; B33Y 70/00; B33Y 80/00; B22F 2998/10; B22F 2301/35; B22F 9/082

(57) ABSTRACT

A printed metallic part is provided. The alloy has the composition of Fe at 69.2 wt. % to 89.1 wt. %; Cr at 7.25 wt. % to 16.0 wt. %; Nb at 0.01 wt. % to 10.0 wt. %; Mo at 0.5 wt. % to 4.0 wt. %. C at 0.03 wt. % to 0.4 wt. % and optionally one or more of Ni, Cu, Si, W, Mn, N and B. The printed metallic part has a tensile strength of at least 1300 MPa, a yield strength of at least 700 MPa, an elongation of at least 4.0%, and a hardness of at least 45 HRC.

### CROSS-REFERENCE TO RELATED APPLICATIONS

This application claims the benefit of U.S. provisional application Ser. No. 63/009,818 filed Apr. 14, 2020, the disclosure of which is hereby incorporated in its entirety by reference herein.

### TECHNICAL FIELD

The application is directed at ferrous alloy compositions that produce metallic parts using direct energy deposition additive manufacturing or 3D printing methods.

### BACKGROUND

Additive manufacturing, also known as 3D printing, typically involves the layer-by-layer deposition of the material to “build” or “print” a part in three dimensions. Manufacturing in this way has numerous advantages over traditional subtractive methods, including the ability to produce complex geometries otherwise not possible to manufacture, rapid part production times, and material cost savings.

There are several processes available for metal 3D printing. In a subset of these, the metal precursor, in either wire or powder form, is melted using a focused energy source such as a laser or electron beam, and is then “directed” to a specific location on the part being built where it solidifies in a “deposition” style manner. This process is generally known as directed energy deposition (DED) with common variants known as direct laser deposition (DLD), laser engineer net shaping (LENS), direct metal deposition (DMD), shaped metal deposition (SMD), and laser metal deposition (LMD). For the purposes of this disclosure, these processes will be referred to generally as DED so as to be independent of power source.

### SUMMARY

In at least one embodiment, ferrous alloy compositions are provided that produce metallic parts with relatively high hardness, strength, and/or ductility when made using direct energy deposition additive manufacturing or 3D printing methods. These properties are achieved by formulating the chemistries of these alloys to develop phases and microstructures in the presence of processing conditions (i.e. times and temperatures) experienced in the direct energy deposition process.

In at least one embodiment, a method of layer-by-layer construction of a part by direct energy deposition is provided. An alloy is supplied in powder, or particle form with the composition of Fe at 69.2 wt. % to 89.1 wt. %; Cr at 7.25 wt. % to 16.0 wt. %; Nb at 0.01 wt. % to 10.0 wt. %; Mo at 0.5 wt. % to 4.0 wt. %; C at 0.03 wt. % to 0.4 wt. % and optionally one or more of Ni, Cu, Si, W, Mn, N and B. One or more layers of the alloy are applied onto a substrate by melting the alloy into a molten state and cooling and solidifying. The metallic part has a tensile strength of at least 1300 MPa, a yield strength of at least 700 MPa, a elongation of at least 4.0%, and a hardness of at least 45 HRC.

According to another embodiment, one or more of Ni, Cu, Si, W, Mn, N and B are optional and if present, fall in the following range: Ni (1.5 wt. % to 4.0 wt. %), Cu (0.1 wt. % to 3.0 wt. %), Si (0.1 wt. % to 1.0 wt. %), W (0.1 wt. % to 6.0 wt. %), Mn (0.4 wt % to 1.9 wt. %), N (0.03 wt. % to 1.0 wt. %) and B (0.01 wt. % to 0.05 wt. %).

According to another embodiment, layers having a thickness in the range of 20 microns to 1000 microns thick layers.

According to another embodiment, the metal may be deposited at a rate typically around from 0.5 kg/hr to 10 kg/hr.

In at least one embodiment, a printed metallic part is provided. The alloy has the composition of Fe at 69.2 wt. % to 89.1 wt. %; Cr at 7.25 wt. % to 16.0 wt. %; Nb at 0.01 wt. % to 10.0 wt. %; Mo at 0.5 wt. % to 4.0 wt. %. C at 0.03 wt. % to 0.4 wt. % and optionally one or more of Ni, Cu, Si, W, Mn, N and B. The printed metallic part has a tensile strength of at least 1300 MPa, a yield strength of at least 700 MPa, an elongation of at least 4.0%, and a hardness of at least 45 HRC.

According to another embodiment, the printed metallic part has a tensile strength of at least 1300 MPa and up to 2200 MPa, a yield strength of at least 700 MPa and up to 1500 MPa, an elongation of at least 4% and up to 20%, and a hardness of at least 45 HRC and up to 58 HRC.

According to another embodiment, the alloy has Fe at 82.0 wt. % to 87.0 wt. %; Cr at 10.5 wt. % to 12.0 wt. %; Ni at 1.5 wt. % to 2.5 wt. %; Nb at 0.02 wt. % to 0.05 wt. %; Cu at 0.1 wt. % to 0.6 wt. %; Mo at 1.2 wt. % to 1.8 wt. %; Si 0.1 wt. % to 0.5 wt. %; C at 0.15 wt. % to 0.22 wt. %; and N at 0.03 wt. % to 0.08 wt. %.

According to another embodiment, the alloy has Fe at 82.0 wt. % to 87.0 wt. %; Cr at 11.0 wt. % to 13.5 wt. %; Ni at 1.5 wt. % to 2.5 wt. %; Nb at 0.02 wt. % to 0.05 wt. %; Cu at 0.1 wt. % to 0.4 wt. %; Mo at 1.5 wt. % to 2.1 wt. %; Si 0.1 wt. % to 0.5 wt. %; C at 0.17 wt. % to 0.25 wt. %; and N at 0.02 wt. % to 0.06 wt. %.

According to another embodiment, the alloy has Fe at 79.0 wt. % to 83.0 wt. %; Cr at 10.5 wt. % to 12.0 wt. %; Ni at 2.8 wt. % to 3.8 wt. %; Nb at 0.04 wt. % to 0.08 wt. %; Cu at 0.1 wt. % to 0.6 wt. %; Mo at 2.5 wt. % to 3.5 wt. %; Si at 0.1 wt. % to 0.5 wt. %; W at 0.1 wt. % to 1.0 wt. %; C at 0.20 wt. % to 0.25 wt. %; and N at 0.05 wt. % to 0.13 wt. %.

According to another embodiment, the alloy has Fe 79.0 wt. % to 83.0 wt. %; Cr at 7.7 wt. % to 9.0 wt. %; Ni at 1.5 wt. % to 2.5 wt. %; Nb at 0.04 wt. % to 0.08 wt. %; Mo at 1.2 wt. % to 1.8 wt. %; W at 4.1 wt. % to 5.5 wt. %; Mn at 0.4 wt. % to 1.1 wt. %; C at 0.15 wt. % to 0.22 wt. %; N at 0.05 wt. % to 0.13 wt. %; and B at 0.01 wt. % to 0.05 wt. %.

### BRIEF DESCRIPTION OF THE DRAWINGS

FIG. 1 is an optical microscopy micrograph of as-built alloy A1 built by OPTOMEC® LENS™ 850-R.

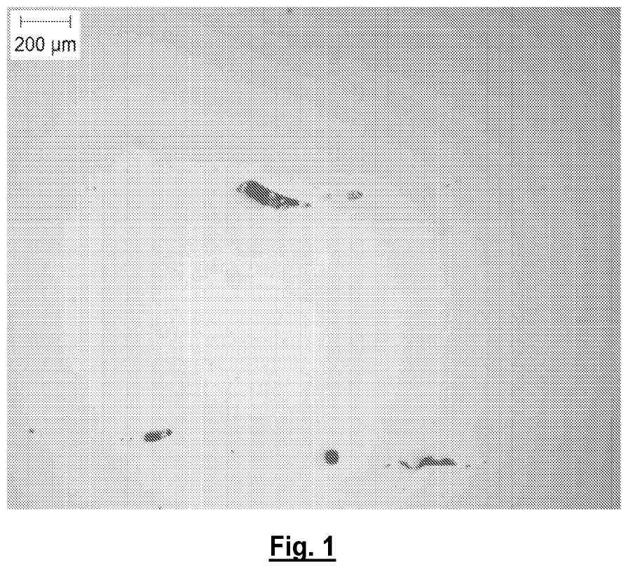

FIG. 2 is an optical microscopy micrograph of as-built alloy A1 built by OPTOMEC® LENS™ 850-R after etching to reveal the microstructure.

FIG. 3 is a scanning electron microscopy (SEM) micrograph of as-built alloy A1 built by OPTOMEC® LENS™ 850-R) after etching to reveal the microstructure.

FIG. 4 is an X-ray diffraction spectrum for as-built alloy A1 built by OPTOMEC® LENS™ 850-R.

FIG. 5 is an equilibrium phase diagram for alloy A1 calculated using Thermo-Calc software.

FIG. 6 is an equilibrium phase diagram for alloy A2 calculated using Thermo-Calc software.

FIG. 7 is an equilibrium phase diagram for alloy A3 calculated using Thermo-Calc software.

FIG. 8 is an equilibrium phase diagram for alloy A4 calculated using Thermo-Calc software.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Directed energy deposition (DED) process for metal 3D printing may use a feed nozzle to propel powder into an energy source. This allows DED to manufacture relatively large-size products with higher printing speeds than additive manufacturing processes that use a powder bed. Besides high productivity, advantages of DED may include the ability to clad or repair previously produced parts as well as to create multi-material components.

DED processes also may utilize certain conditions during processing, such as sustained baseline elevated temperatures, periodic thermal excursions, and rapid cooling rates that can be leveraged to form and develop desirable phases and microstructures that result in unique properties. While historically wrought or cast steel alloys can be used in DED systems, including 316L, 17-4PH, H13, and M300, they were not developed with the DED processes in mind. Therefore, there are opportunities to develop new steel alloy compositions specifically for DED that can achieve mechanical properties similar to or better than current wrought or cast alloys.

The present application discloses metal alloy compositions that exhibit a combination of printability by direct energy deposition (DED) methods and mechanical properties. Specifically the metal alloy compositions may have a relatively high hardness (between 45 HRC and 58 HRC), relatively high strength (yield between 700 MPa and 1500 MPa, tensile between 1300 MPa and 2200 MPa), and/or relatively high ductility (between 4% and 20% elongation) in the “as-built” state.

In DED-based additive manufacturing, printability herein refers to the ability to print a metal alloy on a DED machine. The printing is such that it may occur without defects that would compromise the use of the printed part for a given application, such as cracking and porosity, without imposing conditions that encumber the process, such as elevating process temperature or time. The “as-built” condition is defined as that produced by the DED machine and may be without any post-printing processing that manipulates the microstructure, such as heat treating. The “heat treated” condition refers to the state of the printed metal after it has been exposed to a thermal process designed to alter the microstructure to achieve certain properties.

The present disclosure relates to alloys containing the following concentrations of elements: Fe at 69.2 wt. % to 89.1 wt. %, Cr at 7.2 wt. % to 16.0 wt. %, Ni up to 4.0 wt. %, Nb at 0.01 wt. % to 10.0 wt. %, Cu up to 3.0 wt. %, Mo at 0.5 wt. % to 4.0 wt. %, Si up to 1.0 wt. %, W up to 6.0 wt. %, Mn up to 1.9 wt. %, C at 0.03 wt. % to 0.4 wt. %, N up to 1.0 wt. %, and B up to 0.25 wt. %. Accordingly, Ni, Cu, Si, W, Mn, N and B are optional and if present, may fall in the following range: Ni (1.5 wt. % to 4.0 wt. %), Cu (0.1 wt. % to 3.0 wt. %), Si (0.1 wt. % to 1.0 wt. %), W (0.1 wt. % to 6.0 wt. %), Mn (0.4 wt % to 1.9 wt. %), N (0.03 wt. % to 1.0 wt. %) and B (0.01 wt. % to 0.05 wt. %).

In at least one embodiment, the alloys are free of Co for low environmental, health and safety (EH&S) risk. That is, the level of Co may be less than 0.1 wt. %. In another embodiment, the level is less than 0.05 wt. %. Some embodiments may not contain Tungsten (W), Manganese (Mn) or Boron (B). Some embodiments contain W; some embodiments contain Mn; some embodiments contain both W and Mn; and some embodiments contain B.

Examples of embodiments of alloys according to the present disclosure are listed in Table 1.

TABLE 1

| Element | A1 | | A2 | | A3 | | A4 | |
|---|---|---|---|---|---|---|---|---|
| Fe | 82.0 to 87.0 | wt. % | 82.0 to 87.0 | wt. % | 79.0 to 83.0 | wt. % | 79.0 to 83.0 | wt. % |
| Cr | 10.5 to 12.0 | wt. % | 11.0 to 13.5 | wt. % | 10.5 to 12.0 | wt. % | 7.7 wt. % to 9.0 wt. % | |
| Ni | 1.5 to 2.5 | wt. % | 1.5 to 2.5 | wt. % | 2.8 to 3.8 | wt. % | 1.5 to 2.5 | wt. % |
| Nb | 0.02 to 0.05 | wt. % | 0.02 to 0.05 | wt. % | 0.04 to 0.08 | wt. % | 0.04 to 0.08 | wt. % |
| Cu | 0.1 to 0.6 | wt. % | 0.1 to 0.4 | wt. % | 0.1 to 0.6 | wt. % | — | |
| Mo | 1.2 to 1.8 | wt. % | 1.5 to 2.1 | wt. % | 2.5 to 3.5 | wt. % | 1.2 to 1.8 | wt. % |
| Si | 0.1 to 0.5 | wt. % | 0.1 to 0.5 | wt. % | 0.1 to 0.5 | wt. % | — | |
| W | — | | — | | 0.1 to 1.0 | wt. % | 4.1 to 5.5 | wt. % |
| Mn | — | | — | | — | | 0.4 to 1.1 | wt. % |
| C | 0.15 to 0.22 | wt. % | 0.17 to 0.25 | wt. % | 0.20 to 0.25 | wt. % | 0.15 to 0.22 | wt. % |
| N | 0.03 to 0.08 | wt. % | 0.02 to 0.06 | wt. % | 0.05 to 0.13 | wt. % | 0.05 to 0.13 | wt. % |

| | | | | | |
|---|---|---|---|---|---|
| B | — | — | — | 0.01 to 0.05 | wt. % |

The alloys may be supplied for the DED process in particle form made from conventional methods. The particles are may be produced using gas or water atomization processes with either nitrogen or argon gas for the former. The particles may have a diameter in the range of 1 micron to 500 microns. In another embodiment, the particles may have a diameter in the range of 10 microns to 300 microns. In a further embodiment, the particles may have a diameter in the range of 45 microns to 250 microns.

DED parts are may be built from the metal alloys herein using commercially available DED machines such as the OPTOMEC® LENS™ 850-R. The parts may be built in an inert atmosphere, such as in argon gas. Parts may be built on a substrate that is preheated up to 800° C. In another embodiment, the substrate may be preheated in the range of 50° C. to 200° C. In another embodiment, the substrate may be preheated in the range of in the range of 50° C. to 100° C. In addition, no preheating of the substrate can be employed. The metal substrate may be composed of 1018 steel. However, it is contemplated that other steel and non-ferrous alloys can be used as substrates.

The DED procedure herein contemplates a build-up of individual layers of the alloys each having a thickness 20 microns and higher. In one embodiment, the individual layers of alloys each have a thickness in the range of 20 to 2000 microns. In another embodiment, the individual layers of alloys each have a thickness in the range of 40 to 1000 microns. In another embodiment, the individual layers of alloys each have a thickness in the range of 100 to 800 microns.

The beam diameter may be in the range of 0.1 mm to 50 mm. In another embodiment, the beam diameter may be in the range of 0.4 mm to 10 mm. In another embodiment, the beam diameter may be in the range of 0.6 mm to 4 mm.

The write speed of the printing nozzle may have a speed in the range of 2.5 to 250 cm/min. In another embodiment, the printing nozzle has a write speed in the range of 50 to 150 cm/min. In another embodiment, the printing nozzle has a write speed in the range of 75 to 105 cm/min.

The method of construction involves deposition by melting the metal powder in an atmosphere with less than or equal to 50 ppm oxygen content. In another embodiment, the atmosphere may be less than or equal to 40 ppm oxygen content, or ≤30 ppm oxygen, or ≤20 ppm oxygen, or ≤10 ppm oxygen, or ≤5 ppm oxygen, or ≤1.0 ppm oxygen and directing it to a specified location on a substrate at room temperature or preheated between 50° C. to 800° C. where it solidifies. It is contemplated that in one embodiment, that the level of oxygen may be in the range of 0.1 ppm to 50 ppm. In another embodiment, the level of oxygen may be in the range of 0.1 ppm to 10 ppm. In another embodiment, the level of oxygen may be in the range of 0.1 ppm to 5.0 ppm. In another embodiment, the level of oxygen may be in the range of 0.1 ppm to 2.5 ppm.

Because defects such as porosity and cracking can negatively impact the performance of a part, it is preferable that defects are minimized in as-built parts made from these alloys using the DED process. Specifically, the average porosity in a part may be less than 1.0%. In another embodiment, the average porosity in a part may be less than 0.5%. In another embodiment, the average porosity in a part may be less than 0.3%. Low porosity and no cracking in as-built parts with the metals alloys described herein is evidenced in the cross-section optical micrograph image shown in Error! Reference source not found, which is of a part made with alloy A1 by the OPTOMEC® LENS™ 850-R. This part is made to a height of 25 mm using 0.5 mm to 1 mm thick layers on a 1018 steel substrate with no pre-heating. The average porosity is 0.22% as measured per ASTM E1245-03 (2016), which involves optical image analysis of a micrographic taken at 50× of a metallographic cross-section of the part.

Table 2 shows the mechanical properties of as-built parts produced from traditional commercial steel alloys in comparison to the alloys A1, A2, A3, and A4 described herein in Table 1 using DED. Properties of alloys A1, A2, A3, and A4 were measured on parts built using a OPTOMEC® LENS™ 850-R built on a 1018 substrate with no preheating to height of 25 mm, using 0.5-1 mm layers. It is to be appreciated that alloy A1 described herein exhibits yield and tensile strengths that exceed those of currently available steels also built using DED, including 316L, M300, 17-4 PH, and H13. Furthermore, that alloy A1 has a combination of high strength and elongation (i.e. ductility) that is not present in the currently available steels.

TABLE 2

| | Tensile Strength | Yield Strength | Elongation | Hardness |
|---|---|---|---|---|
| Alloy | (MPa) | (MPa) | (%) | (HRC) |
| 316L | 622 | 423 | 57.5 | — |
| M300 | 1025 | 706 | 19 | — |
| 17-4 PH | 1091 | 777 | 16 | 34 |
| H13 | 1431 | 851 | 3 | 58 |
| (A1) | 1727 | 1378 | 16 | 51 |
| (A2) | 1652 | 1129 | 5 | 51 |
| (A3) | 1960 | 1026 | 9 | 53 |
| (A4) | 2091 | 1000 | 11 | 54 |

As seen in Table 2, alloys described herein in the as-built condition have a high tensile strength of at least 1300 MPa. In another embodiment, the alloys in the as-built condition may have a tensile strength of at least 1500 MPa. In another embodiment, the alloys in the as-built condition may have a tensile strength of at least 1600 MPa. In another embodiment, the alloys in the as-built condition may have a tensile strength in the range of 1300 MPa to 2200 MPa. In another embodiment, the alloys in the as-built condition may have a tensile strength in the range of 1600 MPa to 2100 MPa.

The alloys achieve a high tensile strength in combination with a high yield strength. In one embodiment, the yield strength is at least 700 MPa. In another embodiment, the yield strength is at least at least 900 MPa. In another embodiment, the alloys may have a yield strength in the range of 700 MPa to 1500 MPa.

These tensile and yield strengths are also achieved in combination with elongation of at least 4%. In another embodiment, the elongation may be at least 5%. In another embodiment, the elongation may be in the range of 4% to 20%. In another embodiment, the elongation may be in the range of 4% to 17%.

This tensile strength, yield strength, and elongation are also achieved in combination with a hardness (HRC) of at least 45 HRC. In another embodiment, the hardness may be at least 50 HRC. In another embodiment, the hardness may be in the range of 45 HRC to 58 HRC. In another embodiment, it contemplated herein that hardness herein may be in the range of 50 HRC to 58 HRC.

Accordingly, it should be appreciated that the alloys herein are such that they can have a tensile strength of at least 1300 MPa, a yield strength of at least 700 MPa, an elongation of at least 4%, and a hardness of at least 45 HRC. Other combinations of tensile strength, yield strength, elongation and hardness may be realized in as-built parts from the individual preferred levels of tensile strength, yield strength, elongation, and hardness.

Table 2 illustrates the alloys according to the present invention having high yield and tensile strength and hardness. For example, in one embodiment, the metallic part of alloy A1 has tensile strength of at least 1400 MPa. The alloy A1 may have yield strength of at least 1000 MPa. The alloy A1 may have elongation of at least 10.0%. The alloy A1 may have hardness of at least 46 HRC. In one embodiment, the metallic part of alloy A2 has tensile strength of at least 1300 MPa. The alloy A2 may have yield strength of at least 800 MPa. The alloy A2 may have elongation of at least 4%. The alloy A2 may have hardness of at least 46 HRC. In one embodiment, the metallic part of alloy A3 has tensile strength of at least 1600 MPa. The alloy A3 may have yield strength of at least 700 MPa. The alloy A3 may have elongation of at least 6%. The alloy A3 may have hardness of at least 48 HRC. In one embodiment, the metallic part of alloy A4 has tensile strength of at least 1700 MPa. The alloy A4 may have yield strength of at least 700 MPa. The alloy A4 may have elongation of at least 8%. The alloy A4 may have hardness of at least 49 HRC.

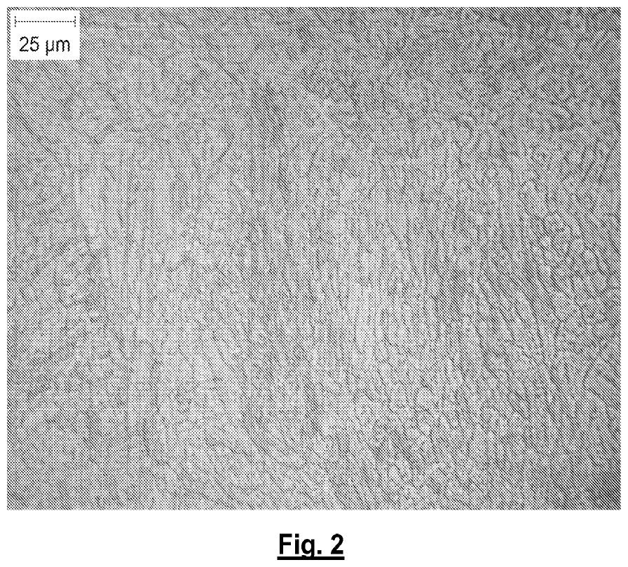

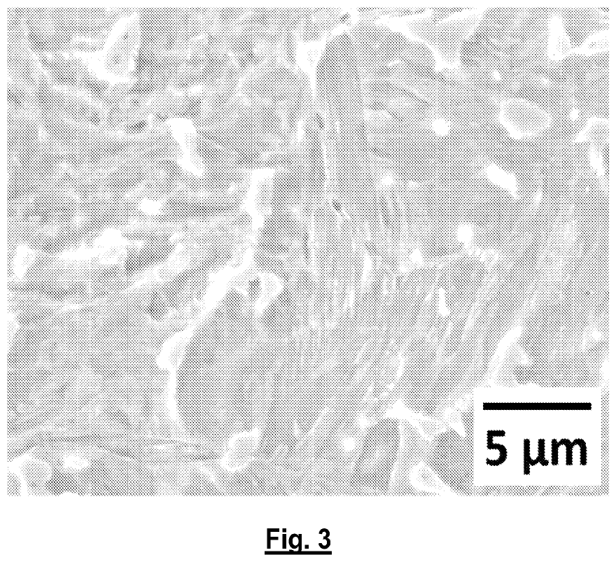

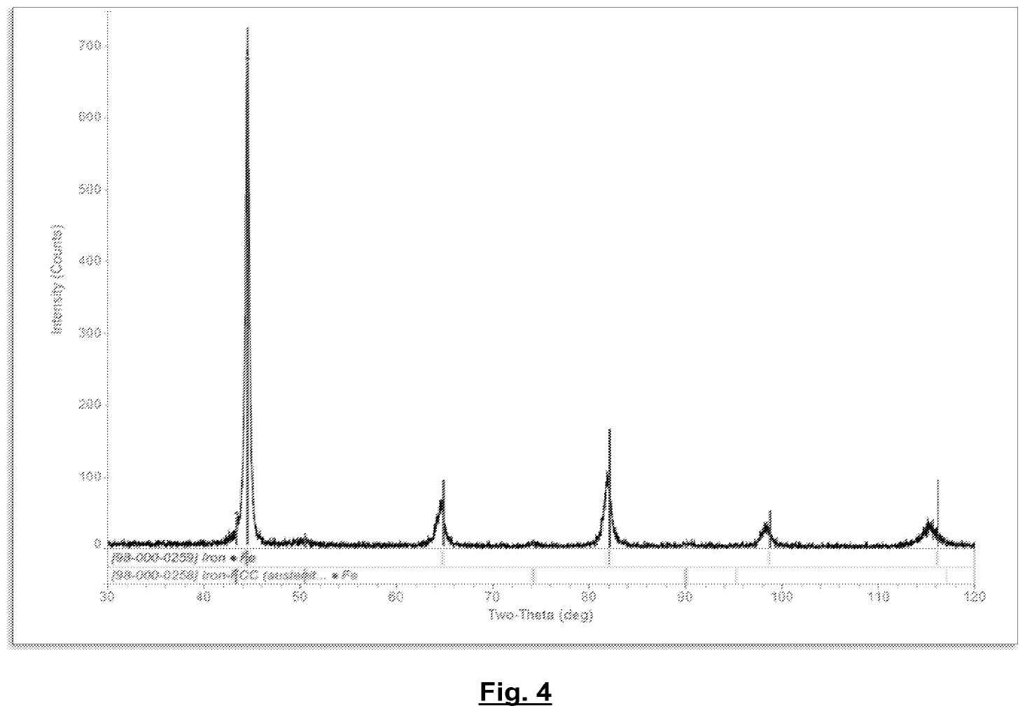

X-ray diffraction (XRD) spectrum of a part made from alloy A1 seen in FIG. 4 is evidence of the presence of martensite/ferrite (BCC) and austenite (FCC) phases in the as-built structure. The X-ray diffraction spectrum was collected using a Bruker D5000 X-ray diffractometer with Cu Kα radiation. Martensite/ferrite and austenite are also observed in micrographs of the microstructure collected by optical and scanning electron microscopy (SEM) as seen in FIG. 2 and FIG. 3, respectively. The part was built using a by the OPTOMEC® LENS™ 850-R built on a 1018 substrate with no preheating to height of 25 mm, using 0.5-1 mm layers.

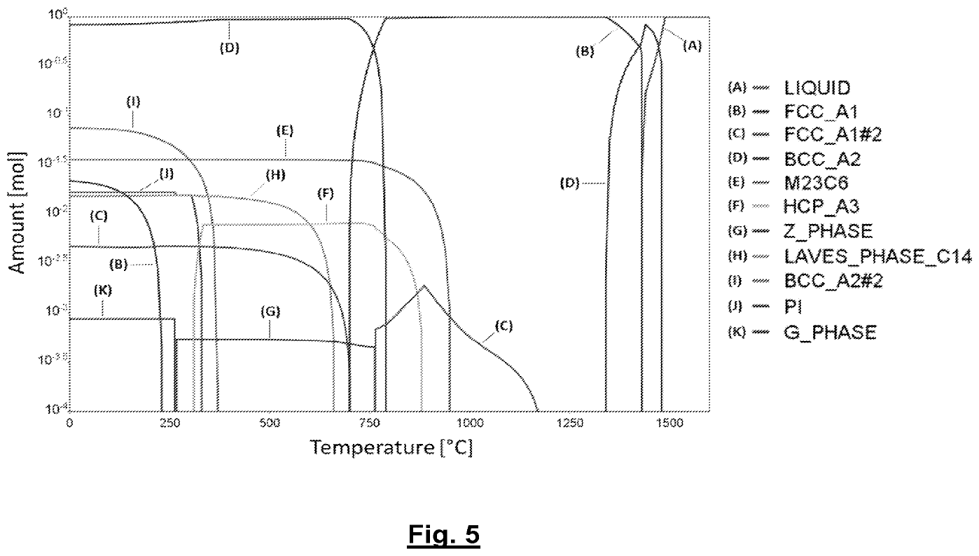

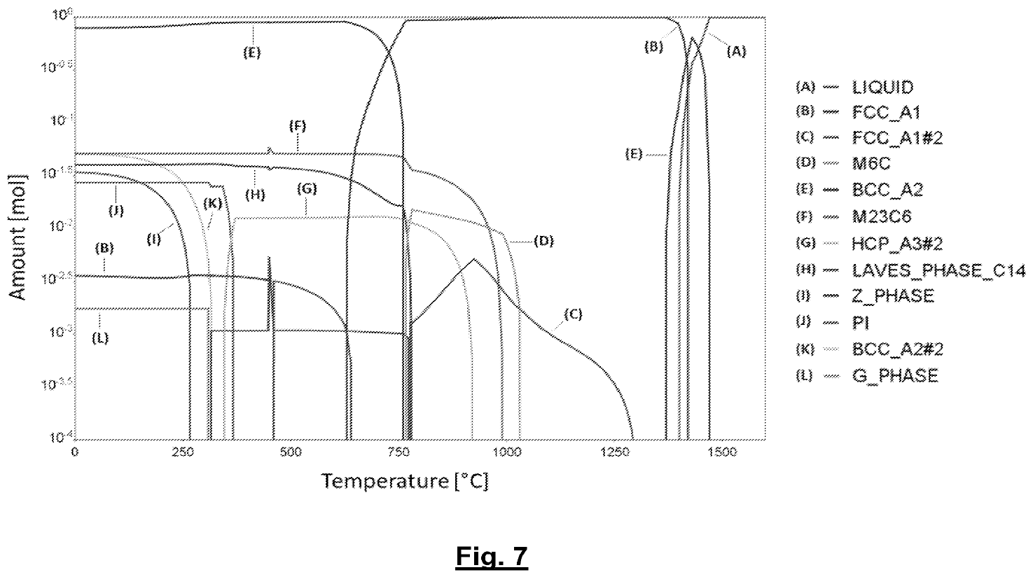

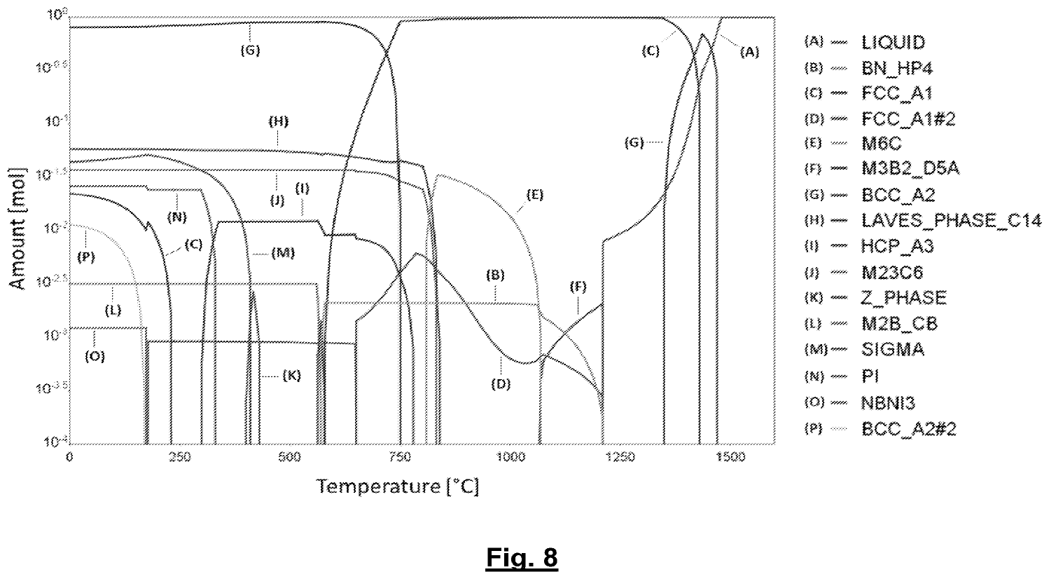

FIG. 5 is an equilibrium phase diagram of alloy A1 generated by Thermo-Calc software (Thermo-Calc Software, Inc., version 2018b, TCFE9: TCS Steels/Fe-alloys Database, v9). Consistent with the XRD and microscopy data, the phase diagram predicts the primary phases in the structure are preferably of body centered cubic (BCC) and face centered cubic (FCC) phases. Also predicted are several secondary phases that are contemplated to form during solidification and/or during repetitive heating cycles from deposition of subsequent and adjacent layers during the printing process. These phases are predicted by the phase diagram to be various carbides, nitrides, and carbonitrides. Equilibrium phase diagrams generated for alloys A2, A3, and A4, which are seen in FIG. 7 and FIG. 8, respectively, also predict similar construction of primary and secondary phases as alloy A1. In some instances, similar or different secondary carbides, nitrides, and carbonitrides are present.

It is contemplated that the combination of the primary and secondary phases contribute to the measured high strength, hardness, and ductility (e.g. elongation) of alloys A1, A2, A3, and A4 described herein compared to currently available steel alloys for DED processes. The phases are governed by the chemistry and the processing conditions specific to the DED processes.

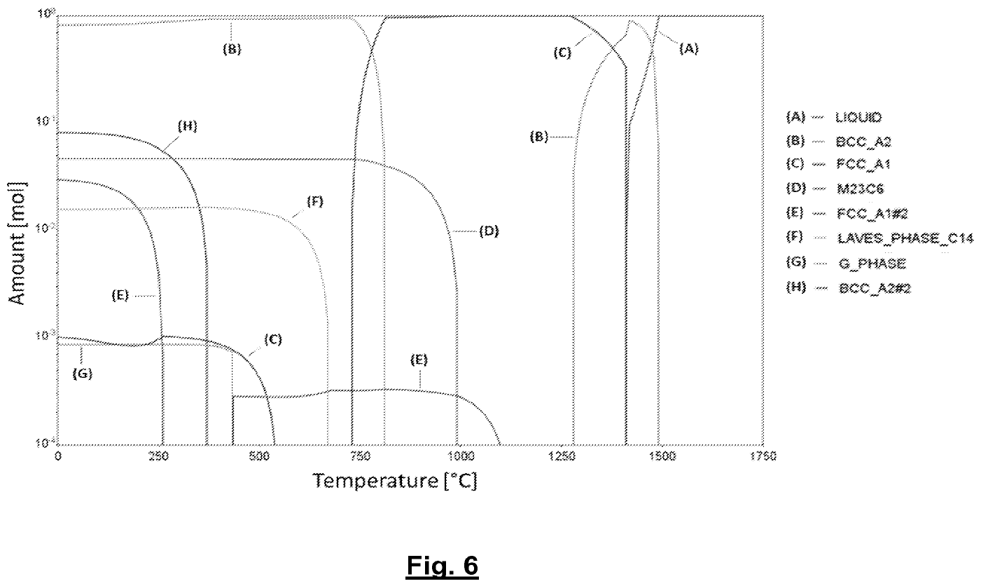

Based on the calculated equilibrium phase diagram in FIG. 5, FIG. 6, FIG. 7 and FIG. 8, it is contemplated that these alloys can be heat treated by conventional quench and temper processes to enhance and/or alter the properties. In alloys A1, A2, A3, and A4, heating the alloys to 1000° C. or above, but below the solidus temperature, results in dissolution of more than 99% (mol faction), if not all of the secondary phases and the formation of austenite phase (FCC). In quench and temper processes, this is known as solutionizing or austenitizing the alloy. After solutionizing for a certain time, the alloy is quenched, or cooled rapidly, to room temperature in order to facilitate the conversion of austenite into martensite and prevent or limit the formation of secondary phases. The alloy can then be heated to temperatures between room and solutionizing temperatures to reduce residual stress as well as to form select secondary phases and grow these phases to certain sizes to optimize a desired property, a step known as tempering or aging.

It is further contemplated that these alloys can undergo surface treatments such as nitriding, carburizing, and carbonitriding or that coatings can be applied by conventional methods such as physical vapor deposition (PVD), chemical vapor deposition (CVD), and plasma. Such processes and methods are commonly used on steels in industry to locally augment the properties of the steel or part at the surface for a desired performance in a specific application.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of layer-by-layer construction by direct energy deposition of a metallic part comprising:
supplying an alloy in particle form comprising the following elements: Fe at 69.2 wt. % to 89.1 wt. %; Cr at 7.25 wt. % to 16.0 wt. %; Nb at 0.01 wt. % to 10.0 wt. %; Mo at 0.5 wt. % to 4.0 wt. %. C at 0.03 wt. % to 0.4 wt. % and optionally one or more of Ni, Cu, Si, W, Mn, N and B;
supplying a substrate; and
applying one or more layers of the alloy onto the substrate by melting the alloy into a molten state and cooling and solidifying;
wherein the metallic part has the following properties: tensile strength of at least 1300 MPa, yield strength of at least 700 MPa, elongation of at least 4.0%, and hardness of at least 45 HRC.

2. The method of claim 1, wherein the layers have a thickness of 20 microns to 1000 microns.

3. The method of claim 1, wherein the alloy comprises Fe at 82.0 wt. % to 87.0 wt. %; Cr at 10.5 wt. % to 12.0 wt. %; Ni at 1.5 wt. % to 2.5 wt. %; Nb at 0.02 wt. % to 0.05 wt. %; Cu at 0.1 wt. % to 0.6 wt. %; Mo at 1.2 wt. % to 1.8 wt. %; Si 0.1 wt. % to 0.5 wt. %; C at 0.15 wt. % to 0.22 wt. %; and N at 0.03 wt. % to 0.08 wt. %.

4. The method of claim 1, wherein the alloy comprises Fe at 82.0 wt. % to 87.0 wt. %; Cr at 11.0 wt. % to 13.5 wt. %; Ni at 1.5 wt. % to 2.5 wt. %; Nb at 0.02 wt. % to 0.05 wt. %; Cu at 0.1 wt. % to 0.4 wt. %; Mo at 1.5 wt. % to 2.1 wt. %; Si 0.1 wt. % to 0.5 wt. %; C at 0.17 wt. % to 0.25 wt. %; and N at 0.02 wt. % to 0.06 wt. %.

5. The method of claim 1, wherein the alloy comprises Fe at 79.0 wt. % to 83.0 wt. %; Cr at 10.5 wt. % to 12.0 wt. %; Ni at 2.8 wt. % to 3.8 wt. %; Nb at 0.04 wt. % to 0.08 wt. %; Cu at 0.1 wt. % to 0.6 wt. %; Mo at 2.5 wt. % to 3.5 wt. %; Si at 0.1 wt. % to 0.5 wt. %; W at 0.1 wt. % to 1.0 wt. %; C at 0.20 wt. % to 0.25 wt. %; and N at 0.05 wt. % to 0.13 wt. %.

6. The method of claim 1, wherein the alloy comprises Fe 79.0 wt. % to 83.0 wt. %; Cr at 7.7 wt. % to 9.0 wt. %; Ni at 1.5 wt. % to 2.5 wt. %; Nb at 0.04 wt. % to 0.08 wt. %; Mo at 1.2 wt. % to 1.8 wt. %; W at 4.1 wt. % to 5.5 wt. %; Mn at 0.4 wt. % to 1.1 wt. %; C at 0.15 wt. % to 0.22 wt. %; N at 0.05 wt. % to 0.13 wt. %; and B at 0.01 wt. % to 0.05 wt. %.

7. The method of claim 1, wherein the substrate is heated to a temperature of less than or equal to 800° C.

8. The method of claim 1, wherein the metallic part undergoes solutionizing at a temperature of or greater than 900° C. followed by quenching.

9. The method of claim 7, wherein the metallic part is tempered at temperatures at or above room temperature.

10. The method of claim 1, wherein the metallic part undergoes a process to alter the surface structure and properties including carburizing, nitriding, carbonitriding, and deposition of coatings.

11. A printed metallic part comprising:
Fe at 69.2 wt. % to 89.1 wt. %; Cr at 7.25 wt. % to 16.0 wt. %; Nb at 0.01 wt. % to 10.0 wt. %; Mo at 0.5 wt. % to 4.0 wt. %. C at 0.03 wt. % to 0.4 wt. % and optionally one or more of Ni, Cu, Si, W, Mn, N and B;
wherein the printed metallic part indicates a tensile strength of at least 1300 MPa, yield strength of at least 700 MPa, elongation of at least 4.0%, and hardness of at least 45 HRC.

12. The printed metallic part of claim 11, wherein the part comprises one or more layers having a thickness of 20 microns to 1000 microns.

13. The printed metallic part of claim 11, wherein the alloy comprises Fe at 82.0 wt. % to 87.0 wt. %; Cr at 10.5 wt. % to 12.0 wt. %; Ni at 1.5 wt. % to 2.5 wt. %; Nb at 0.02 wt. % to 0.05 wt. %; Cu at 0.1 wt. % to 0.6 wt. %; Mo at 1.2 wt. % to 1.8 wt. %; Si 0.1 wt. % to 0.5 wt. %; C at 0.15 wt. % to 0.22 wt. %; and N at 0.03 wt. % to 0.08 wt. %.

14. The printed metallic part of claim 13, wherein the metallic part has tensile strength of at least 1400 MPa, yield strength of at least 1000 MPa, elongation of at least 10.0%.

15. The printed metallic part of claim 11, wherein the alloy comprises Fe at 82.0 wt. % to 87.0 wt. %; Cr at 11.0 wt. % to 13.5 wt. %; Ni at 1.5 wt. % to 2.5 wt. %; Nb at 0.02 wt. % to 0.05 wt. %; Cu at 0.1 wt. % to 0.4 wt. %; Mo at 1.5 wt. % to 2.1 wt. %; Si 0.1 wt. % to 0.5 wt. %; C at 0.17 wt. % to 0.25 wt. %; and N at 0.02 wt. % to 0.06 wt. %.

16. The printed metallic part of claim 15, wherein the metallic part has tensile strength of at least 1300 MPa, yield strength of at least 800 MPa and hardness of at least 46 HRC.

17. The printed metallic part of claim 11, wherein the alloy comprises Fe at 79.0 wt. % to 83.0 wt. %; Cr at 10.5 wt. % to 12.0 wt. %; Ni at 2.8 wt. % to 3.8 wt. %; Nb at 0.04 wt. % to 0.08 wt. %; Cu at 0.1 wt. % to 0.6 wt. %; Mo at 2.5 wt. % to 3.5 wt. %; Si at 0.1 wt. % to 0.5 wt. %; W at 0.1 wt. % to 1.0 wt. %; C at 0.20 wt. % to 0.25 wt. %; and N at 0.05 wt. % to 0.13 wt. %.

18. The printed metallic part of claim 17, wherein the metallic part has tensile strength of at least 1600 MPa, and hardness of at least 48 HRC.

19. The printed metallic part of claim 11, wherein the alloy comprises Fe 79.0 wt. % to 83.0 wt. %; Cr at 7.7 wt. % to 9.0 wt. %; Ni at 1.5 wt. % to 2.5 wt. %; Nb at 0.04 wt. % to 0.08 wt. %; Mo at 1.2 wt. % to 1.8 wt. %; W at 4.1 wt. % to 5.5 wt. %; Mn at 0.4 wt. % to 1.1 wt. %; C at 0.15 wt. % to 0.22 wt. %; N at 0.05 wt. % to 0.13 wt. %; and B at 0.01 wt. % to 0.05 wt. %.

20. The printed metallic part of claim 19, wherein the metallic part has tensile strength of at least 1700 MPa, and hardness of at least 49 HRC.
